(19) United States
(12) Patent Application Publication
(10) Pub. No.: US 2009/0235346 A1
(43) Pub. Date: Sep. 17, 2009

(54) System and method for augmented user and site authentication from mobile devices

(76) Inventor: Joseph Steinberg, Teaneck, NJ (US)

Correspondence Address: KLAUBER & JACKSON, 411 HACKENSACK AVENUE, HACKENSACK, NJ, 07601, US

(21) Appl. No.: 12/218,990

(22) Filed: Jul. 18, 2008

Related U.S. Application Data
(60) Provisional application No. 60/961,157, filed on Jul. 19, 2007.

(51) Int. Cl. H04L 9/32; G06F 21/00

(52) U.S. Cl. 726/8

(57) ABSTRACT

A system and method for augmented user and site authentication from mobile devices is disclosed herein. The system and method provides for the performing of strong authentication of users, whether human or otherwise, as well as of site authentication, which is optimized for use when such users access a system from a mobile device using a web browser or mini-web browser. In doing so the claimed invention utilizes multiple different heuristic algorithms and/or scoring values for device identification based on the type of mobile device, and may further identify the specific type of device attempting such access.

### RELATED APPLICATIONS

The present application claims priority from U.S. Provisional Patent Application Ser. No. 60/961,157 filed on Jul. 19, 2007. Applicant claims priority under 35 U.S.C. §119 as to said U.S. provisional application, and the entire disclosure of that application is incorporated herein by reference in its entirety.

### BACKGROUND OF THE INVENTION

Although secret passwords have been used for millennia to prove one's identity and/or to ensure that a party is authorized to access a specific resource, the use of passwords as a method of authentication nevertheless poses risks. For example, if an unauthorized party discovers, intercepts, or otherwise obtains a password the unauthorized party can gain inappropriate access to sensitive resources. In today's electronic age, sensitive information can be accessed, and transactions can be executed online, after unseen parties authenticate, and to this end, stronger forms of authentication are often appropriate.

Furthermore, even after a user has been authenticated to a particular system, there may be occasions in which additional authentication is advisable. For example, if a user is performing a high-dollar-value online transaction on an online banking or ecommerce application, or where a user is accessing personal health information of a sensitive nature, it may be advisable to perform an extra authentication prior to execution of that particular transaction. Multi-factor authentication, which has been used on computers and for physical access to sensitive facilities, consists of requiring parties to prove their identity though the use of two or more of the following: (1) Something that the party or parties know (e.g., a password, the answer to a predetermined question and answer pair such as “mother's maiden name, etc.); (2) Something that they possess (e.g., a physical device, a specific digital certificate, etc.); (3) Something that they are/biometrics (e.g., thumb print match, retinal scan match, etc.).

As those skilled in the art will recognize, multi-factor authentication typically excludes the use of two of the same types of authentication. For example, providing two distinct passwords is not an example of two-factor authentication (it is an example of two single factor authentications), while providing a password and a thumbprint are. Likewise, providing a password and answering a question are not dual factor authentication they are simply the use of a single factor (something the user knows) two times.

It should be noted that neither something that users posses, nor a representation of something that that a user is, are absolutely secure, but rather bound by realities of practicality. For example, a digital certificate present on a user's computer that is used for authentication is an example of something that the user possesses even though it is theoretically possible for someone to know the bits of the certificate and re-create it, but because doing so is extremely impractical, it is essentially beyond the scope of realistic possibility. Passwords, on the other hand, are normally much simpler and can be seen written down, heard when repeated, unlike client certificates which are normally unlikely to ever be seen or repeated byte by byte. However, both certificates and passwords may be compromised by various means. For example, just as one may re-create the bits of certificate, a phishing site can easily ask for a user's password and mother's maiden name (or any similar piece of information in conjunction with a password), and as such, is not a good way to ensure security and prevent online fraud. As those skilled in the art will recognize, site authentication is needed in order to protect against phishing and related types of fraud, as two-factor authentication on its own often does not protect against such threats. Criminals can, for example, collect multi-factor authentication information from users (e.g., one time passwords) and use such information to perform a multi-factor authentication to the real sites in real time. Hence, even known multi-factor authentication may not offer enough security for today's users.

As those skilled in the art will recognize, while mobile devices (e.g., Palm Treo series of devices, RIM's BlackBerry series of devices, Apple's iphone, Motorola's Q phone, etc.) have been used as authentication devices (one example of this is illustrated by the running of a one-time password generator on a user's mobile device so that the user may use that one time code when logging into a website from his computer to prove that he is possession of the mobile device) they offer very limited authentication when it comes to access from the devices to systems using their built in Internet access. Multi-factor and site authentication have not historically been performed for access to systems when users are operating from their mobile devices, and as such, mobile portals often offer limited access; users cannot fully access a business system using their mobile device's web-browser/mini-web-browser, and must instead use a laptop or desktop computer for complete access. Unfortunately, the limitations surrounding mobile access have persisted as security needs demand appropriate authentication, yet there currently exists no site authentication optimized for mobile access, and furthermore, the more secure combination of site authentication and multi-factor authentication optimized for access from mobile devices also does not exist.

### SUMMARY OF THE INVENTION

The present invention therefore addresses the above-described inadequacies of known systems by providing a system, method, and computer product that provides strong authentication of systems to mobile users (or to mobile devices) and users on mobile devices (or the devices themselves) to systems (where users themselves may also be systems) with minimum inconvenience. In doing so, the present invention optimized authentication for mobile access points, and also provides for the more secure combination of site authentication and multi-factor authentication for mobile devices that are accessing secure websites. At its broadest level, the present invention provides for a system having modules and a method thereof for performing optimized authentication from a mobile device comprising the steps of: providing multiple forms of strong authentication to a mobile device as part of at least a single authentication model when the mobile device is accessing a system; optimizing the strong authentication so as to leverage unique particulars of a mobile environment according to at least the steps comprising: testing the mobile device accessing the system to make a determination as to specific capabilities of the mobile device; and using more than one user-experience for multi-factor authentication according to said determination as to specific capabilities of said mobile device. In a further embodiment the present invention further modules and a method for performing optimized authentication from a mobile device of by: performing site authentication; refreshing smaller cookies or other time stamps used during; authenticating on mobile devices at substantially every login to prevent cookies or other timestamps used during authentication from circling out; utilizing multiple different heuristic algorithms or scoring values for device identification based upon a determined type of access device; pre-fetching site authentication web pages for said mobile device without storing user information on the device.

### BRIEF DESCRIPTION OF DRAWINGS

This invention will be better understood by referring to the accompanying drawings, wherein:

FIGS. 1-5 are screen-shot based illustrative depictions of how a user might interface with the inventive system; and

FIGS. 6-7 are illustrative flow depictions of exemplary processes within the inventive system.

### DETAILED DESCRIPTION

Among the elements of this invention are several unique components—which may be implemented independently or together. Theses unique components provide site authentication optimized for mobile access so that users (whether human or machine) may access online systems from their mobile devices without users from falling prey to phishing (including classic phishing as well as pharming and related attacks), and other online scams. Such protections are of particular value to mobile users because while mobile access-based activities (e.g., banking from mobile devices, shopping from mobile devices, etc.) may offer users greater convenience, they nevertheless introduce serious risks of phishing and online fraud, because such handheld devices typically do not have any anti-phishing technology built in, and this deficiency—coupled with the fact that mobile websites are simpler than standard websites and therefore easier to clone—makes it easier for criminals to implement phony web sites that mimic legitimate mobile-enabled sites.

The present invention ameliorates these risks by performing site authentication (e.g., confirming the true identity of the site) so as to reduce the risk of users being tricked by criminals (e.g., “phishers” and the like) into thinking they are communicating with a legitimate system, when, in fact, they are communicating with a criminal replica of the system. The inventive site authentication can take the form of a colored word on a colored background (i.e., on a colored box), an image, a phrase, or other easily recognizable item that has been optimized or customized for the mini-screens of mobile devices.

Such inventive site authentication elements can be generated mathematically (or from a database or both) in a way that addresses the unique limitations that mobile devices have when compared to laptop or desktop computers. Historically, site authentication could not be done on mobile devices for many reasons, including the fact that site authentication: (a) often involved multiple steps during login, and given that mobile devices have slow connections and slow rendering of web pages when compared to computers, such a process became a major inconvenience for users; (b) used significant portions of “screen real estate” and mobile devices have very small screens with little available space; and/or (c) used technology that was not available on mobile devices—such as adding toolbars to a web browser, something that can be done on computers, but which is not offered by the browsers on mobile devices, or the use of interactive processes such as those offered by AJAX which are available on computers, but not on today's mobile devices. With the current invention, visual cues are generated through mathematical functions as described in U.S. patent application Ser. Nos. 11/258,593, filed Apr. 27, 2004, 11/114,945, filed Apr. 27, 2004, 60/742,498, filed Dec. 5, 2005, and 11/606,788, filed Apr. 27, 2004 (each of which are hereby incorporated by reference in their entireties), but are modified in such a way as to permit their use on a mobile device, in order to allow for site authentication that can actually be accomplished in an efficient and user-friendly manner on mobile devices. To this end, and as described below, the method of delivery of the site authentication cues will often be different on mobile devices than on computers in order to provide this customization for mobile devices.

In one embodiment, the present invention contemplates the use of multi-factor authentication from a mobile device, in combination with site authentication delivered to the mobile device. Multi-factor authentication can entail techniques such as sending a one-time password to a user via email or SMS. While sending the message to a pre-agreed-upon cell phone is the stronger of the two methods of authentication (since the user must physically possess that cell phone and must know his password), emailing the one time password is also appropriate, as it is far less likely that a user would agree to submit passwords to two distinct unrelated systems (e.g., to the site being phished and to his general email system). To this end, the use of a one time password emailed to a user—while not necessarily truly multi-factor authentication—might therefore be considered quasi-multi factor, and its use in conjunction with another two-factor system in order to deliver convenient (at least) two-factor authentication from a mobile device is included in this invention as true two-factor authentication. Accordingly, this multi-factor authentication better ensures that the user is who he claims to be, and eliminates the situation where strong authentication is required when users access systems from computers, but not when such users access said systems from mobile devices, thereby allowing mobile access to be a weak entry point into the entire online system. Also, the inventive approach eliminates the opposite situation where online businesses/financial institutions/etc. require overt authentication for computer based users logging into their websites, but not do not provide for such authentication when users logged into their mobile-portals (and thereby are forced to provide less access to mobile-device users than to web users by for example, allowing a mobile-device user to check an account balance, but not allowing that user to make an online payment while logged in from the mobile-device, even while allowing laptop and desktop users to make online payments). The current invention, by providing multi-factor authentication from mobile devices, can enable mobile-device users to be given the full level of access that web (e.g. laptop or desktop computer) users can normally enjoy.

In one embodiment, the present invention further contemplates the use two or more forms of strong authentication from a mobile device as part of a single authentication model. This could be done in order to achieve both security and convenience, and might employ web logins such as those described in U.S. patent application Ser. Nos. 11/258,593, filed Apr. 27, 2004, 11/114,945, filed Apr. 27, 2004, 60/742,498, filed Dec. 5, 2005, and 11/606,788, filed Apr. 27, 2004, but would be modified to accommodate—and be optimized for—the systemic limitations of handheld (mobile) devices. Because mobile devices have far simpler operating systems and far less processing power than laptop or desktop computers, lack the ability to run applets of various sorts that can run on computers (e.g., Active/X of Java), and have smaller screens, many security and multi-factor systems are simply too complex and/or processor-intensive to be used from mobile devices in real world situations. Accordingly, the present invention is not simply a mere replica of the use of inventive approaches for laptop or desktop-based computers, but instead comprises customized, inventive methods of strong authentication that differ from those used on computers. In addition, the present invention provides the aforementioned mobile device-customized inventive methods of strong authentication by leveraging device identification capabilities of the multifactor authentication system and by identifying that a particular mobile device is associated with a particular user so as to achieve several goals including that of “pre-fetching” the appropriate site authentication for that user.

The inventive concept of pre-fetching disclosed herein comprises the performing of site authentication specific to a particular user, wherein the site authentication is delivered to the user upon an initial page load, prior to the user entering any information during a session. Because mobile devices are often used by primarily one user, in a mobile environment site authentication of this type is deemed particularly beneficial. Along these lines, it is, therefore, a very rare phenomenon that multiple users are regular users on a single mobile device, and as such, the mobile user experience may be optimized for the primary device user by providing him (or her) site authentication before he is required to type anything. Part of the invention, therefore, is use of the mobile optimized mechanism by which site authentication cues are displayed prior to a user entering any information into the browser on a mobile device, something which is normally not possible in laptop or desktop computer-based environments if site authentication is based on a user's identity, given that it is not uncommon for multiple users to share a computer (e.g., a home computer). Such cues may be generated based on the identity of the user, based on a certificate, or any other mechanism of providing site authentication. Provision of this step saves time and permits a faster online access, which is especially important in the mobile world given that performance is generally slower than in the laptop or desktop computer-based computer world, yet often offers better security than that which can be obtained in the computer world.

The present invention may further optimize and secure online mobile access by the displaying of site authentication cues using cHTML standards or other mobile-device standards so as to avoid the problem with many authentication systems that simply cannot be exported or applied to the scaled-down browsers used on mobile devices. In doing so, the present invention provides for the use of scaled down protocols intended for use on mobile devices to generate and/or display site authentication cues, and by way of just one example, the present invention might provide for the use of simple text in lieu of images, and for the automatic placement of the cues at the top of subsequently loaded web pages, rather than through dynamic generation using AJAX, Java script, or other interactive technologies.

The inventive technique of displaying site authentication cues or performing multi-factor authentication as optimized for mobile devices may also include the use of different heuristic algorithms or scoring values (or both) for device identification based on whether the device is a mobile device or a computer, or even based on what type of device it is. An exemplary heuristic evaluation may be an inspection method used by computer software or hardware that examines various properties about something (a device, session, or other computer-related entity or concept), and then seeks to extrapolate information from that analysis even through the extrapolation is essentially an educated guess based on probability. For example, seeing many properties of a web session from a particular device X to a web server Y on July 1^{st}, and then on July 2^{nd} seeing a device Z connecting to web server Y that exhibits properties 95% similar to those from device X during the session on July 1st, and extrapolating that these two devices X and Z are likely the same device, or at least stating that the risk of these two being different devices is much smaller than the risk would be with two random devices on the Internet. To this end, many elements, and scoring values and/or weights, may be involved in a heuristic calculation. Furthermore, different “passing scores” (that is scores as to what is considered a match may vary based on which elements match and to what degree. (For example, if a cookie placed on a device is present, maybe the passing score is lower for other heuristics than if it is not.)

The above is identification important because mobile devices often move around, but their browser versions rarely change. By contrast, laptop or desktop computers often exhibit the opposite—browsers being updated often, but never moving. Accordingly, the present invention leverages this technical difference in achieving yet another optimization aspect. In one illustrative example, one heuristic algorithms or scoring approach might be seen in the following simplified example: A user logs in using a connection provided by a specific Internet provider, from a specific location, from a specific IP Number Address, using a specific browser version. If we see that he logs in again (or at least someone using his username and password is logging in) from the same geolocation over the same Internet provider but with a slightly different IP Address we might give this a score of A. Depending on previously established rules A might be considered a device match or may not be.

The particular ways in which this leveraging for multi-factor authentication might further be achieved are numerous. One additional example might be the systematic checking as to who the user's wireless provider is, looking at any available Device ID codes (e.g., if an ESN is available to the authentication system looking at the ESN), what the device type is, etc. as part of the authentication process. Nevertheless, this is not always simple, as one might want authentication to NOT involve installing or running code, other than the web browser on the device, and ESN's are not always retrievable without some such code. It is important to realize that the same information can mean different things when sent from a laptop or desktop computer versus a mobile device. For example, a change of ISP in a computer is not uncommon—especially on a laptop travelling from home to work—but a change of ISP from a cell phone may mean that the user has left his/her regional area or country altogether. If a user has not moved geographically, but has switched ISPs from a cell phone—something may be amiss. Another illustrative example might include an assessment of browser versions, something which often changes on computers, but not on cell phones. Alternatively, one approach might include a geolocation assessment, something which may not change for a home computer or office computer, but will change extremely often for mobile devices. Accordingly, the present invention includes the use of device identification algorithms that assess factors described above, and therefore account for both computers and mobile devices, and treat the information derived from each one differently due to the different nature of their use in the real world. One illustrative example would be treating a system that moves often as still a match if its geolocation changes, but a device that has not moved in X days/weeks/months would be treated differently if it starts to move. Or treating systems running specific browsers (e.g., desktop and laptop computer browsers) differently than those running mobile device browsers in both security policies and authentication/heuristic rules settings.

The present invention may further optimize and secure online mobile access by using smaller cookies that work on more devices, and by refreshing cookies upon each login of a user, so as to prevent their being “cycled out”. Mobile devices often have small memory spaces for cookies and/or cache, as opposed to computers on which cookies are often wiped by users or software for security and/or privacy and/or cleanup reasons, cookies on mobile devices are more often cycled out, that is, there is not enough memory space for a lot of cookies so when a new one is added, an old one might be erased to create space for the new one. To address this, the present invention includes the unique technique of refreshing authentication-related cookies upon each login, so as to keep any such cookie/cookies on the “newer” side of the list and lower the chances of it/they being erased. This refreshing may be accomplished by simply resending the cookie to the device, by resetting its timestamp to the current time, by resetting its expiration date to a new expiration date further away than the one currently in the cookie, etc.

The present invention may further optimize and secure online mobile access by testing a mobile device that is accessing a system to see what capabilities it has, and based on the then-determined capabilities, using more than one user-experience for site authentication and/or user authentication. For example, one test might be determining whether the device supports dynamically generated site authentication cues by displaying a cue as the user types, so that the above-described pre-fetching may be utilized, or if such cues are displayed as a user types, then the page may instead be displayed after the user types, with other techniques herein being utilized to secure the online access. Another test might be to see whether a device runs JavaScript, and if so, what subset of JavaScript does it allow, and what does not allow, as this too will enable the inventive approach to customize the mobile optimization as described above. In yet another embodiment, one test might be to see whether the target mobile device allows frames, CSS, etc. Such tests can also be used for authentication of the devices—the capabilities of mobile devices rarely change, so in determining a match we can test the capabilities on one day and they should be the same on future logins. In any case, these tests are effectuated by sending down various web page instructions and examining the responses (or lack thereof)—it the web server writes a cookie and then tries to read it back and the cookie is not present that might indicate that the device does not accept cookies (or has been configured to reject cookies)—this can also be done in non-mobile (i.e., the computer) world—but, in mobile devices, such settings are much less likely to change from time to time, and, furthermore, other elements CANNOT be changed. For example, trying to run specific java script and seeing the result will let us know if that Java script is supported by the device.

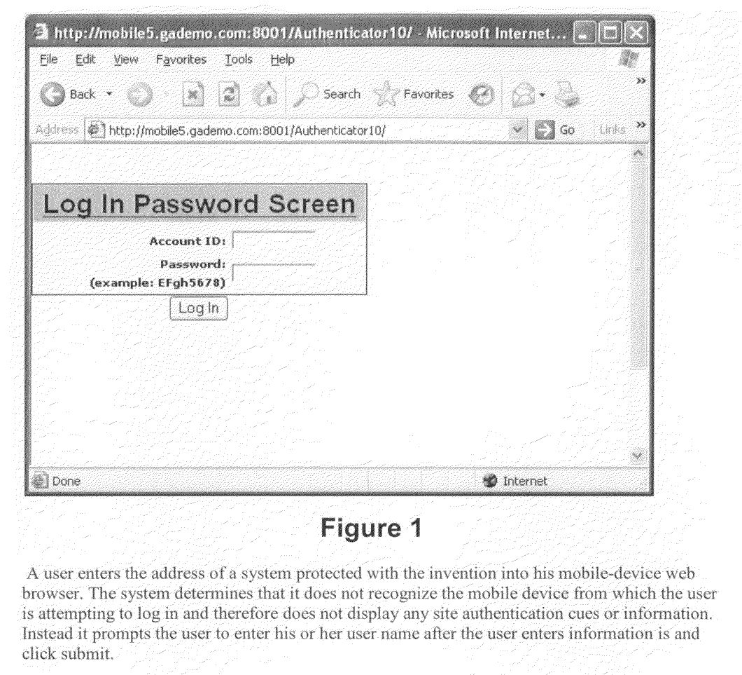

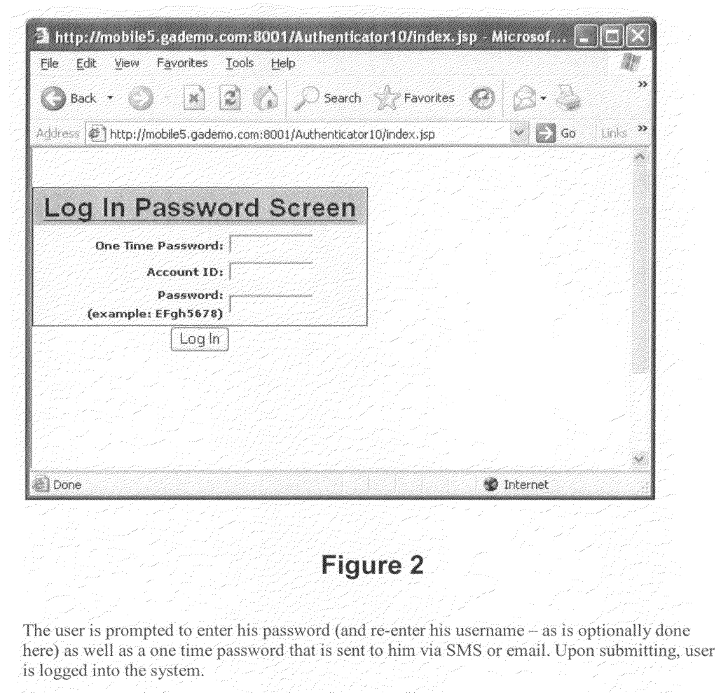

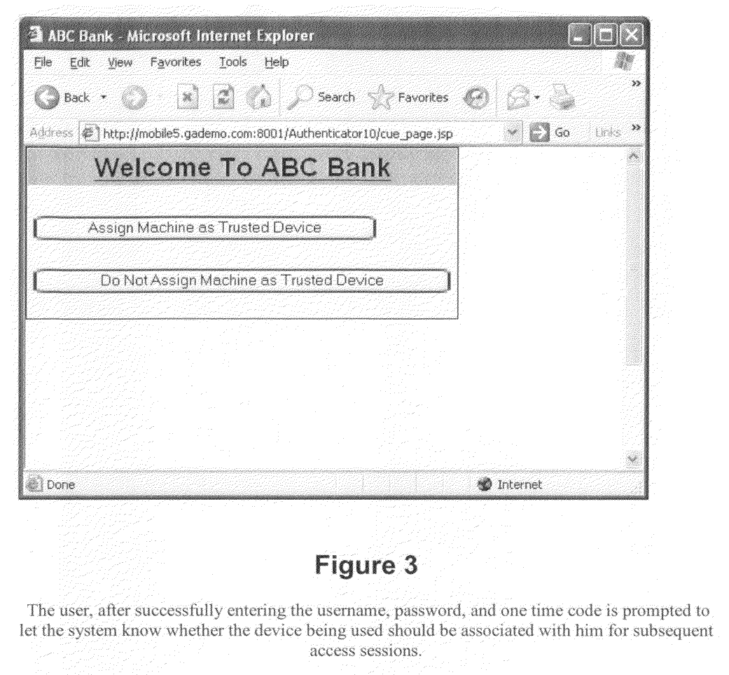

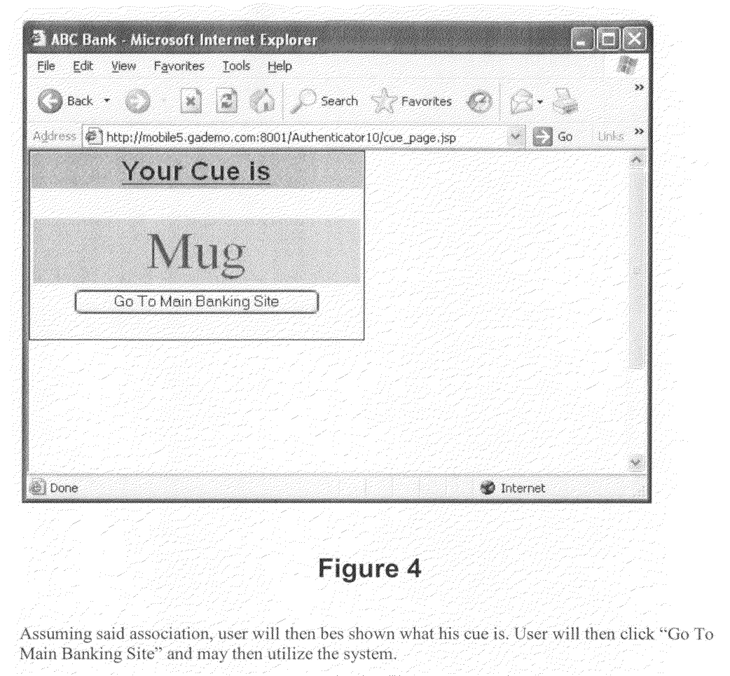

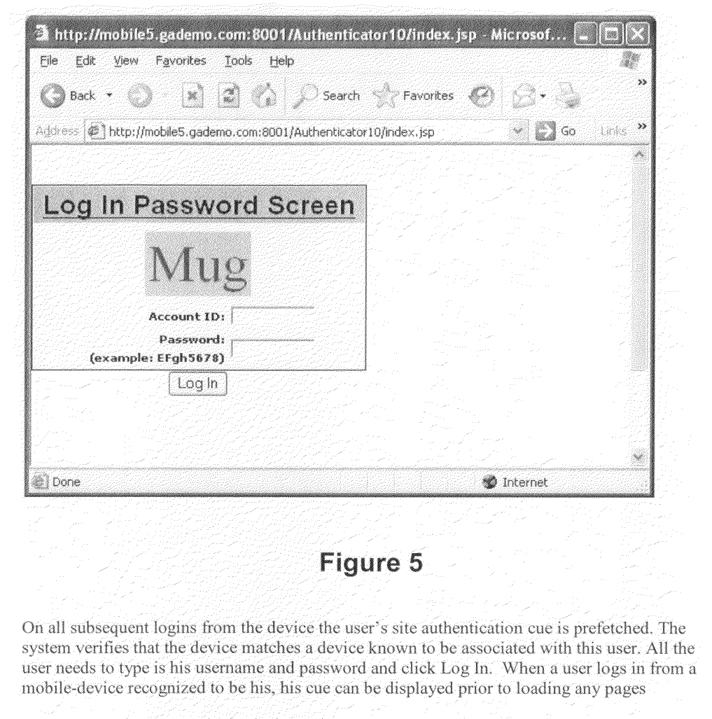

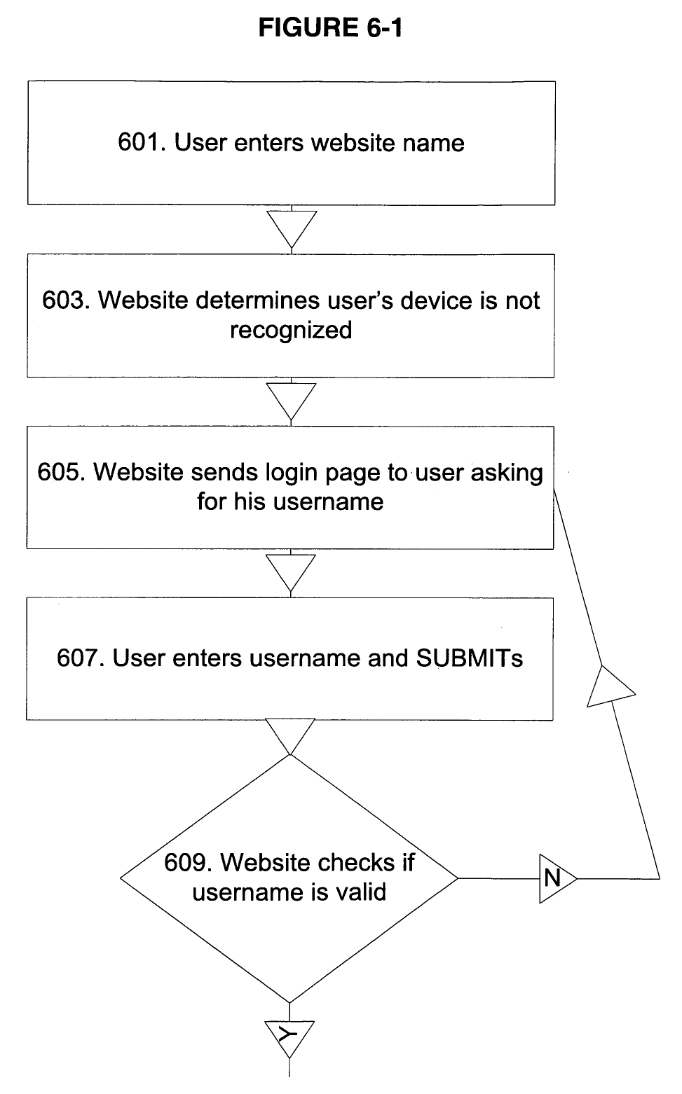

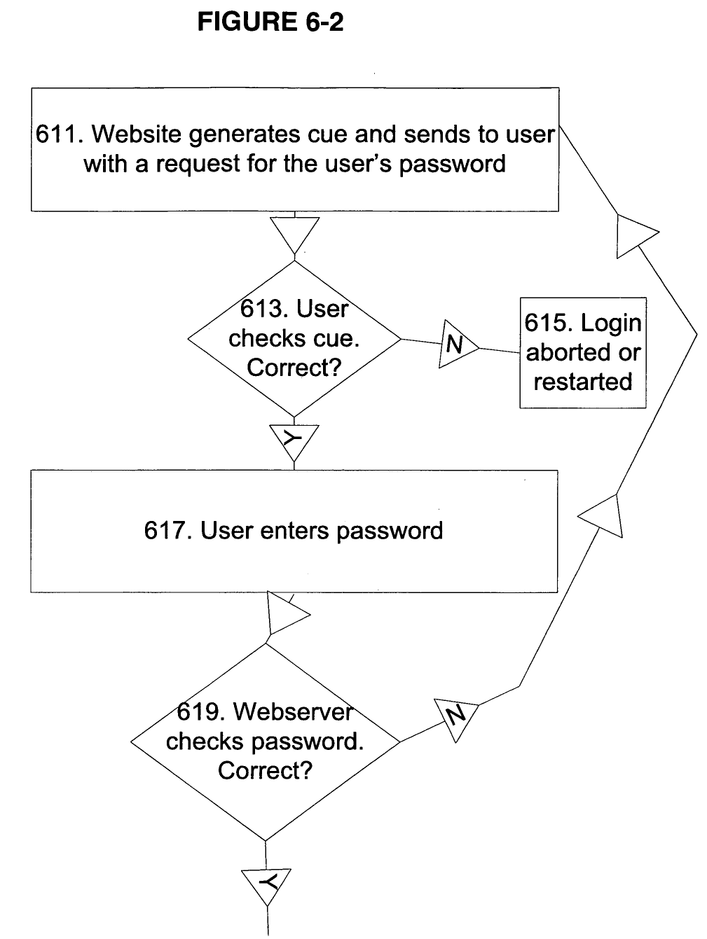

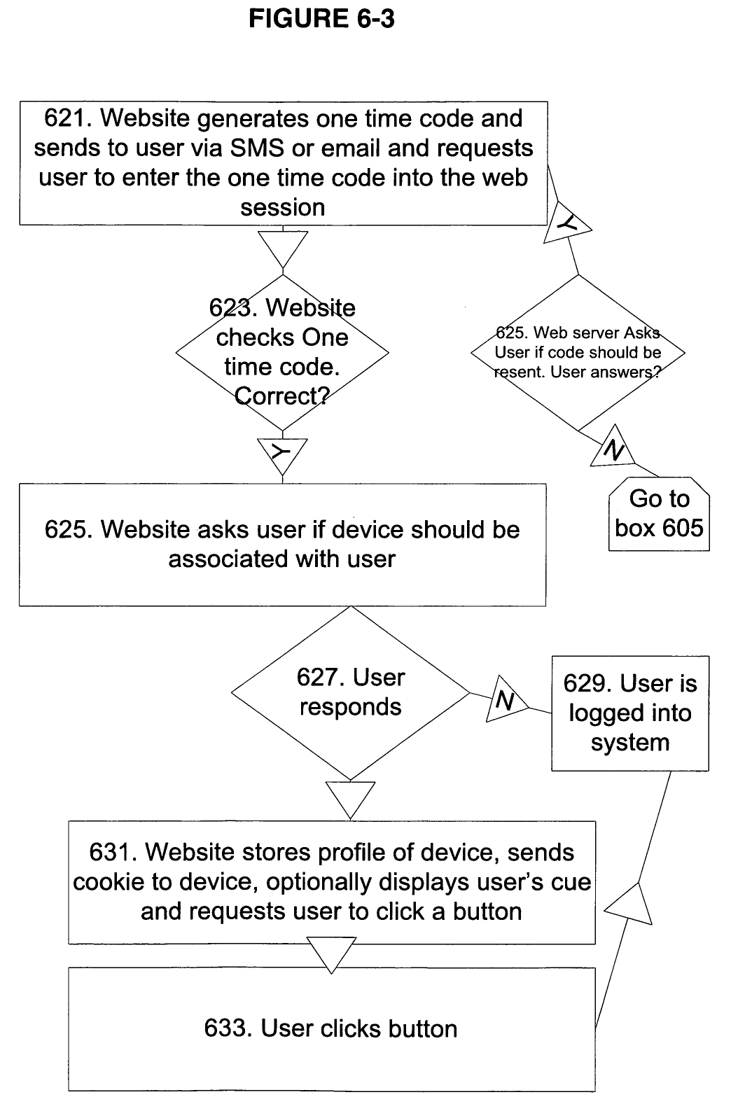

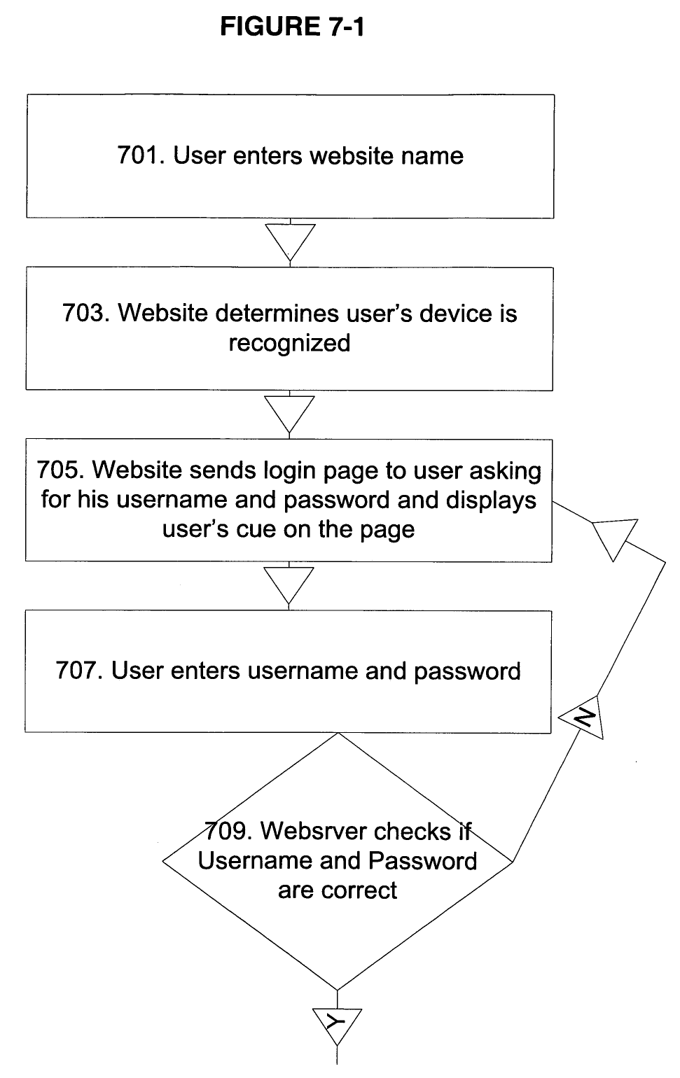

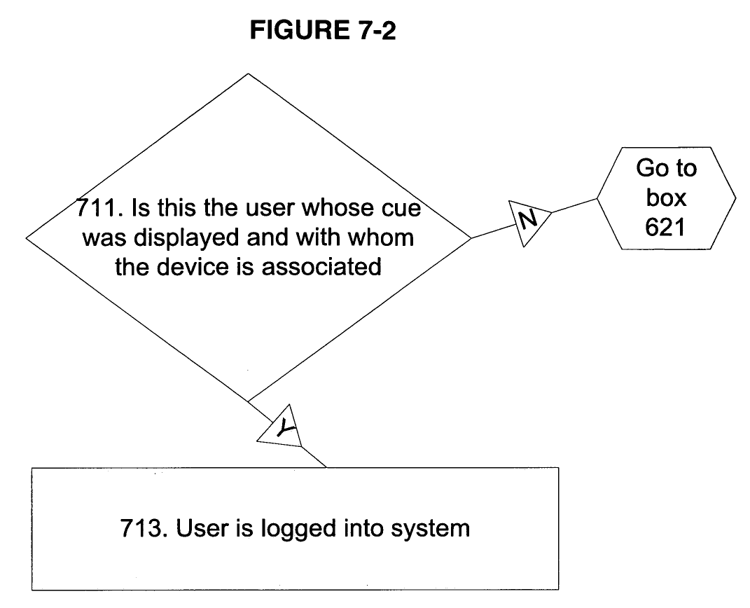

All of the above techniques may be accordingly depicted in one exemplary depiction of one possible visual of corresponding software implementation depicted generally in FIGS. 1-5. Similarly, FIGS. 6 and 7 allow the present invention may be further illustrated with the following exemplary process flows:

Exemplary Process Illustration 1, FIG. 6:
1. User enters the address of the website secured by an implementation of the invention into the browser on his cell phone. Step 601.
2. The website responds—and based on various parameters that it garners from the Web session—for example the IP address of the cell phone/provider, the web browser version found in the HTTP Header, etc.—is able to determine various information about the cell phone for example who the wireless provider is, what model the cell phone is, what browser is being used on the device, etc.—determines that the phone is not one that it knows is associated with a particular user. Step 603.
3. The website sends the user a login page asking him for his username. Step 605.
4. The user enters his username and clicks submit. Step 607.
5. The website then checks if the username is valid and sends a cue to him if so. The cue is generated mathematically as further described in U.S. patent application Ser. Nos. 11/258,593, filed Apr. 27, 2004, 11/114,945, filed Apr. 27, 2004, 60/742,498, filed Dec. 5, 2005, and 11/606,788, filed Apr. 27, 2004. Step 609.
6. The user checks if the cue is correct, and if so enters his password and submits. Step 611.
7. The website checks if the password is correct. If not, it re-prompts the user. If it is correct the website informs the user that it will be sending a one time code via email to the user's pre-known email address or via SMS to the cell phone number known to be valid for the user. Step 613.
8. The website then prompts the user for the code. Step 615.
9. The user receives the code and enters it into the session. Step 617.
10. The website checks if the code is correct. If no, it re-prompts and asks the user if the code should be resent. If yes, it asks the user if this device should be set to be associated with him. Step 619.
11. The user enters YES or NO (or clicks the corresponding button). If he selects No the website simply logs him in. If YES the website sends a cookie to the device and stores the information it garnered in step two in a profile for next time, and then logs him in. Step 621.

Exemplary Process Illustration 2, FIG. 7:
1. User enters the address of the website secured by an implementation of the invention into the browser on his cell phone. Step 701.
2. The website responds—and based on various parameters that it garners from the Web session—for example a cookie it previously placed on the device, the IP address of the cell phone/provider, the browser version from the HTTP header—is able to determine various information about the cell-phone for example who the wireless provider is, what neat and model the cell-phone is, what browser is being used on the device, etc.—determines that it has seen this device before used by user JOHN DOE. Step 703.
3. The website sends the initial login page—we see John Doe's site authentication cue to the cell phone. John does a site authentication according to a cue that had previously been determined during previous logins as specify through the process mentioned in U.S. patent application Ser. Nos. 11/258,593, filed Apr. 27, 2004, 11/114,945, filed Apr. 27, 2004, 60/742,498, filed Dec. 5, 2005, and 11/606,788, filed Apr. 27, 2004. Step 705.
4. The web server refreshes the cookie on the device so it doesn't circle out. Step 707.
5. JOHN DOE enters his username and password and clicks submit. Step 709.
6. The website confirms that John Doe's username and password are correct and double checks that this is in fact a device associated with John Doe from previous logins and if so allows the user to access the system. If the username was John Doe's but the password was not correct the system will re-prompt the user for the password. If the username was not John Doe then the system will check if username entered is also a username associated with this device (which most likely will not be the case) and in which case the system will require the user to enter a one time code sent to a known e-mail address or cell phone (via SMS) associated with that particular username. Step 711.

I claim:

1. A method of performing optimized authentication from a mobile device comprising the steps of:
providing multiple forms of strong authentication to a mobile device as part of at least a single authentication model when said mobile device is accessing a system;
optimizing said strong authentication so as to leverage unique particulars of a mobile environment according to at least the steps comprising:
testing said mobile device accessing said system to make a determination as to specific capabilities of said mobile device; and
using more than one user-experience for multi-factor authentication according to said determination as to specific capabilities of said mobile device.

2. The method of performing optimized authentication from a mobile device of claim 1 further comprising the step of:
performing site authentication.

3. The method of claim 2 further comprising the step of:
refreshing smaller cookies or other time stamps used during authentication on said mobile device at substantially every login to prevent said cookies or other timestamps used during authentication from circling out.

4. The method of claim 3 further comprising the step of:
utilizing multiple different heuristic algorithms or scoring values for device identification based upon a determined type of access device.

5. The method of claim 4 wherein said step of using more than one user-experience for site and multi-factor authentication further comprising the step of:
pre-fetching site authentication web pages for said mobile device without storing user information on the device.

6. A system for performing optimized authentication from a mobile device comprising:
a module for providing multiple forms of strong authentication to a mobile device as part of at least a single authentication model when said mobile device is accessing a system;
a module for optimizing said strong authentication so as to leverage unique particulars of a mobile environment according to at least the steps comprising:
a module for testing said mobile device accessing said system to make a determination as to specific capabilities of said mobile device; and
a module for using more than one user-experience for multi-factor authentication according to said determination as to specific capabilities of said mobile device.

7. The system of performing optimized authentication from a mobile device of claim 6 further comprising:
a module for performing site authentication.

8. The system of claim 7 further comprising:
a module for refreshing smaller cookies or other time stamps used during authentication on said mobile device at substantially every login to prevent said cookies or other timestamps used during authentication from circling out.

9. The system of claim 8 further comprising:
a module for utilizing multiple different heuristic algorithms or scoring values for device identification based upon a determined type of access device.

10. The system of claim 9 wherein said step of using more than one user-experience for site and multi-factor authentication further comprising:
a module for pre-fetching site authentication web pages for said mobile device without storing user information on the device.
